(19) United States
(12) Patent Application Publication
(10) Pub. No.: US 2008/0154761 A1
(43) Pub. Date: Jun. 26, 2008

(54) COMMODITIZATION OF PRODUCTS AND PRODUCT MARKET

(75) Inventors: Gary W. Flake, Bellevue, WA (US); Lili Cheng, Bellevue, WA (US); Nishant V. Dani, Redmond, WA (US); Alexander G. Gounares, Kirkland, WA (US); Jeffrey R. Hemmen, Redmond, WA (US); Eric J. Horvitz, Kirkland, WA (US); Kamal Jain, Bellevue, WA (US); Leonard Smith, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/766,695

(22) Filed: Jun. 21, 2007

Related U.S. Application Data
(60) Provisional application No. 60/870,926, filed on Dec. 20, 2006.

(51) Int. Cl. G06Q 40/00

(52) U.S. Cl. 705/37

(57) ABSTRACT

The claimed subject matter relates to an architecture that can facilitate the commoditization of both products and product markets in resale domains in order to aid in quantifying a value of used product as well as to enhance efficiencies and/or profits in resale markets. In one aspect, the architecture can determine a recommended (e.g., average) price and listing fee for a product. In another aspect, desired (e.g. indicated by the seller) values can be provided and based upon various market factors and differences between the desired values and the recommended values, the architecture can determine a variety of probabilities relating to the conversion of the product, as well as provide suggestions for increases the potential for a conversion. In addition, the architecture can identify and capitalize on arbitrage opportunities within the market.

### CROSS-REFERENCE TO RELATED APPLICATIONS

This application claims the benefit of U.S. Provisional Application Ser. No. 60/870,926, filed Dec. 20, 2006, entitled “ARCHITECTURES FOR SEARCH AND ADVERTISING.” The entirety of this application is incorporated herein by reference.

### BACKGROUND

Conventionally, market providers for previously owned products have been largely the province of auctions and want-ad style listings. For example, resale of a product generally entails the seller creating an account with a suitable venue, and then entering a product description along with an asking price. The host typically posts the listing that can be accessed by potential buyers. If a buyer agrees to the asking price, either in the form of a bid or a buy, then the purchase can be finalized with the buyer taking receipt of the product in exchange for the purchase price and the host taking a listing fee.

Although not always the case, auction style markets generally take a listing fee in the form of percentage of the purchase price and typically do not receive the listing fee unless or until the product is sold. On the other hand, it is common for want-ad style markets to receive a flat listing fee before the product is listed for sale or resale. Each scheme is associated with advantages and disadvantages. For example, up-front listing fees place the risk of non-conversion on the seller which can result in a disincentive for sellers who want to obtain a reasonable price for the product in the face of substantial uncertainty of what a reasonable price actually is. Ultimately, a seller often decides to set the asking price so low, a conversion is virtually certain in order to prevent paying a listing fee for nothing. Conversely, contingent-based fees place the risk of non-conversion on the host but there is no available mechanism to reign in excessive profit-seeking motives of sellers. Thus, listings that generally have no hope for conversion will often utilize resources of the host. Again, largely because conventional resale markets have no means for estimating a “fair” price for a product.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises a computer-implemented architecture that can commoditize products and/or product markets in order to facilitate efficiencies in resale markets. In accordance with these and other related ends, the architecture can acquire, e.g. by way of various data mining techniques, a wealth of product data relating to products that are frequently resold. In addition, the architecture can also obtain a product description from a seller of a product for resale. Based upon an analysis of the product data, and in particular upon empirical data associated similar products or associated transactions, the architecture can determine or infer an approximate worth or value of the product described by the seller as well as an approximate listing fee generally paid to the market for hosting an advertisement for such a product. Accordingly, the architecture can supply to the seller a recommended asking price and a recommended listing fee normally associated with the product for resale. Hence, the seller can be better informed and therefore make more rational judgments regarding various risks and rewards associated with resale of the product.

According to another aspect of the claimed subject matter, the architecture can make a variety of determinations or inferences relating to a likelihood of converting the product in a resale market based upon the desired asking price and the desired listing fee set by the seller. For example, a number of impressions that will likely result in an ad or listing for the product can be inferred. Other examples can include, a probability that an impression will result in a conversion, as well as similar inferences with respect to a designated time period. Such inferences can also be supplied to the seller or the host in order to facilitate more rational and/or more efficient transactions in the resale marketplaces.

In anther aspect of the claimed subject matter, the architecture can identify or capitalize on arbitrage opportunities. For instance, various data mining procedures can, in addition to supplying product data, facilitate the identification of product listings with asking prices that are well below “market price” as can be defined by the recommended asking price determined by the evaluation mechanisms of the architecture. Such products can be purchased at an advantageous price and resold for a profit, potentially increasing liquidity and uniformity in the resale markets as well as providing quantifiable economic profits or gains.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a system that can commoditize both products and product markets in order to, e.g., improve efficiencies and/or profits in resale markets.

FIG. 2 is a block diagram illustrating the acquisition of product data in more detail.

FIG. 3 depicts a block diagram of a system that can facilitate communication with the seller by way of a user-interface.

FIG. 4 is a block diagram illustrating a depiction of one example user-interface.

FIG. 5 is a block diagram of a system that can provide recommendations to increase a likelihood of conversion for the product.

FIG. 6 illustrates a block diagram of a system that can facilitate arbitrage opportunities.

FIG. 7 depicts an exemplary flow chart of procedures that define a method for commoditizing products and/or product markets in order to facilitate improved efficiencies in resale markets.

FIG. 8 is an exemplary flow chart of procedures that define a method for providing inferences and/or suggestions for enhancing market performance.

FIG. 9 illustrates an exemplary flow chart of procedures defining a method for identifying and/or engaging in arbitrage opportunities.

FIG. 10 illustrates a block diagram of a computer operable to execute the disclosed architecture.

FIG. 11 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, or the like can refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

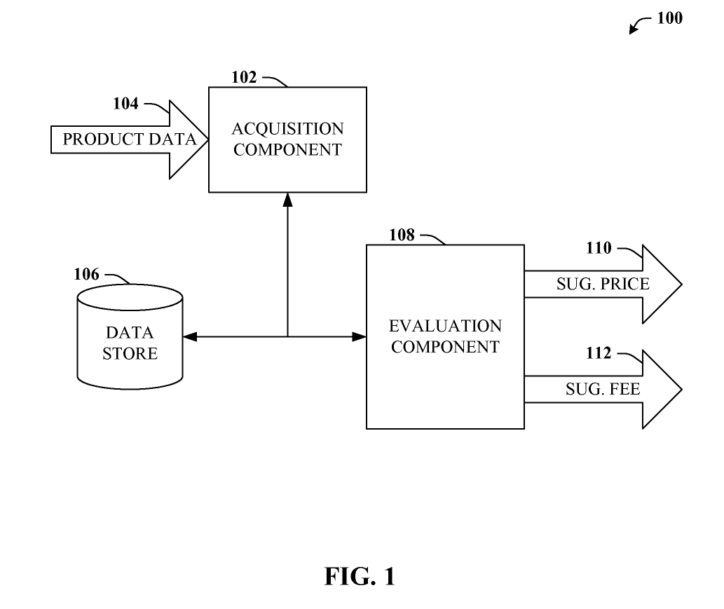

Referring now to the drawing, with reference initially to FIG. 1, a computer-implemented system 100 that can commoditize both products and product markets in order to, e.g., improve efficiencies and/or profits in resale markets is depicted. Generally, the system 100 can include an acquisition component 102 that can obtain product data 104 associated with a product for resale. As used herein, a product for resale is intended to refer to a used product, a product that is frequently sold used, a previously owned product, a product that was previously purchased, in some cases by way of a retail purchase or transaction, or the like. One example of a product that is frequently sold used is a camera, such as a hypothetical Marksman brand XL 5 camera, which will serve as an example product throughout the remainder of the disclosure. However, it is to be appreciated that the claimed subject matter can apply to numerous other types of products, all of which can be considered to be within the spirit and scope of the appended claims.

The product data 104 can include a wide variety of information, including but not limited to a product class such as “automobiles”, “cameras” or “digital cameras”; a product brand such as “Marksman”; a product model such as “XL 5”; an included product accessory such as “a telephoto lens”; a purchase price, which can be an original retail price; a date of purchase or a period of time between a purchase and a listing for resale; a product condition, e.g. at the time of a listing for resale; a number of previous owners; a product features such as built-in flash; an asking price such as a price included in a resale listing; a listing fee, which can be an amount the seller pays to the market or a marketplace host charges to display a listing for resale of the product; a sell-by date or a time period in which the seller desires to convert the product; etc. All or portions of the product data 104 can be stored to a data store 106 for later retrieval.

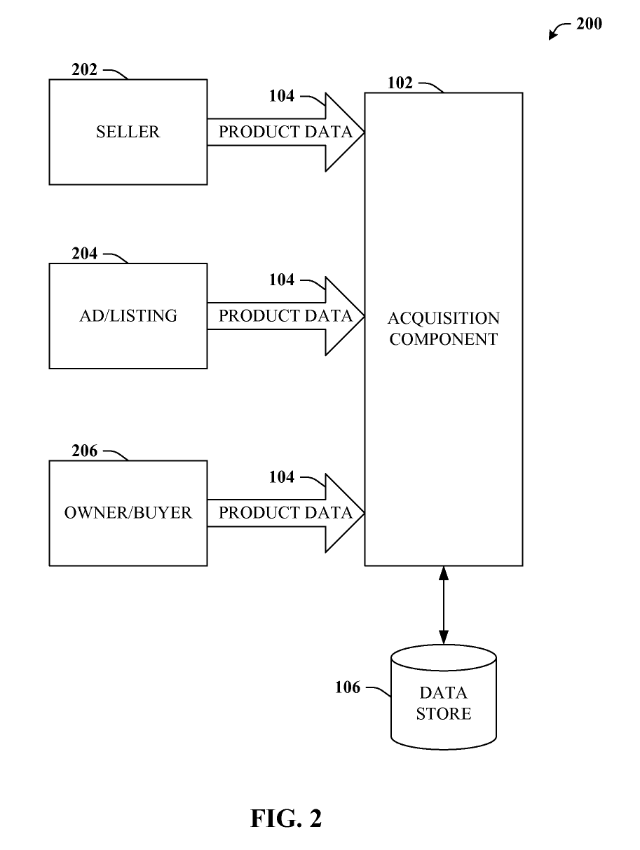

It is to be appreciated that the acquisition component 102 can obtain product data 104 in various ways, which is illustrated in more detail in connection with FIG. 2. Turning briefly to FIG. 2 before continuing the discussion of FIG. 1, a system 200 that illustrates the acquisition of product data 104 in more detail is depicted. The system 200 can include the acquisition component 102 that can receive product data 104 from any or all of a seller 202, an advertisement/listing 204, or an owner/purchaser 206 of the product. In particular, the seller 202 can directly input portions of the product data 104 to describe a product for resale in order to facilitate a conversion of the product and/or to employ other features described herein. Moreover, an owner 206 of the product can directly data relating to the product such as, e.g. a level of satisfaction, a level of quality or performance, a durability or longevity associated with the product, likes, dislikes, as well as expectations thereof prior to a purchase of the product or other reasons that contributed to the purchase. Furthermore, the owner 206 can be provided an economic reward or incentive for supplying these and other related data. For example, the owner 206 can be provided an economic incentive proportional to a determined or inferred value or worth associated with the information provided (e.g., the ten-thousandth report on a Honda Civic might be worth very little, but the first three reports on a new Porsche could be worth a lot).

In addition, the acquisition component 102 can obtain portions of the product data 104 from one or more listings 204 of competing product(s) (e.g., products that are substantially similar in value, features, etc.). Typically, the listings 204 will be available from a third party product market host or venue, such as an auction website, want-ad host, advertisement host, and so on. The product data 104 can be periodically supplied to the acquisition component by the third party host or marketplace, or, additionally or alternatively the acquisition component 102 can employ data mining techniques (e.g. spiders, crawlers, bots, item searches . . . ) and other forms of identification, selection, and/or filtering to locate and gather information relating to products for resale.

For example, the acquisition component 102 can mine a wealth of data from third party ad/listings 204 relating to, e.g. cameras. The product data 104 relating to cameras as well as to virtually any other type of product can be stored to the data store 106 such that when the seller 202 inputs product data 104 in order to resell his or her Marksman XL 5 camera, a very robust and comprehensive data set can be available for baseline comparisons, relative valuation, market nuances, trends, supply, demand, and so on.

Continuing the description of FIG. 1, the system 100 can also include an evaluation component 108 that can, e.g. based upon the product data 104, determine or infer a suggested asking price 110 and a suggested listing fee 112. According to an aspect of the claimed subject matter, the evaluation component 108 can determine the suggested asking price 110 based at least in part upon an asking price associated with one or more competing products, for which associated product data 104 was, e.g. previously acquired from an ad/listing 204. The suggested asking price 110 can, therefore, represent an average, baseline, or approximate value or worth of the product based upon a history of transactions, which can include the price at which the similar (e.g., competing) product sold, a number of and prices associated with bids for the similar product, similar products and asking prices thereof that did not result in a conversion, and the like, all of which can be included in the product data 104 and saved to the data store 106. In accordance therewith, a market for the product can be commoditized in at least an informational sense by the suggested asking price 110 provided by the evaluation component 108.

According to another aspect of the claimed subject matter, the evaluation component 108 can determine or infer the suggested listing fee 112 based, e.g., upon a listing fee associated with one or more product marketplaces such as the hosts, sponsors, or venues that provide access to the ad/listings 204. Whether such marketplaces and/or sponsors employ a flat listing fee, a percentage of the asking price, a percentage of the sale price, or some other scheme, the marketplace host inevitably receives some form of remuneration on the transactions.

By monitoring these associated fees, the evaluation component 108 can potentially determine an average or approximate revenue that is acceptable for the marketplace host in return for hosting a competing product, and by proxy an acceptable suggested listing fee 112 that is appropriate for the product. It is to be appreciated that many other statistical gradations can be gleaned from such data such as the most cost-effective type of marketplace for the product (e.g., an auction versus want-ad style listing), as well as determining an appropriate venue for the product for which the asking price is substantially above/below the suggested asking price 110, or based upon other criteria such as a desired sell-by date.

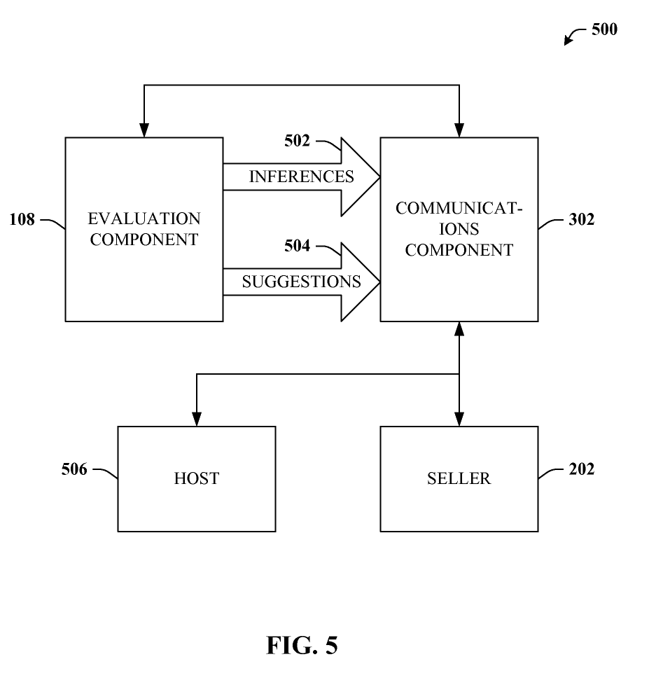

It is to be further appreciated that by gathering an understanding about what the marketplace expects to see out of a transaction can facilitate a commoditization of the marketplace itself, which is further detailed in connection with FIG. 5. However, as one brief example, if it is known that the market typically receives about $1 (e.g., the suggested listing fee 112 is about $1) upon conversion of a particular listing 204 for a competing product, then a subsequent seller (e.g. seller 202) of the product can offer a $2 listing fee to entice the marketplace to host an ad or listing for the product. Accordingly, a marketplace host can proactively “bid” to display the product listing rather than passively waiting for the seller 202 to create an account and post the listing in a conventional manner.

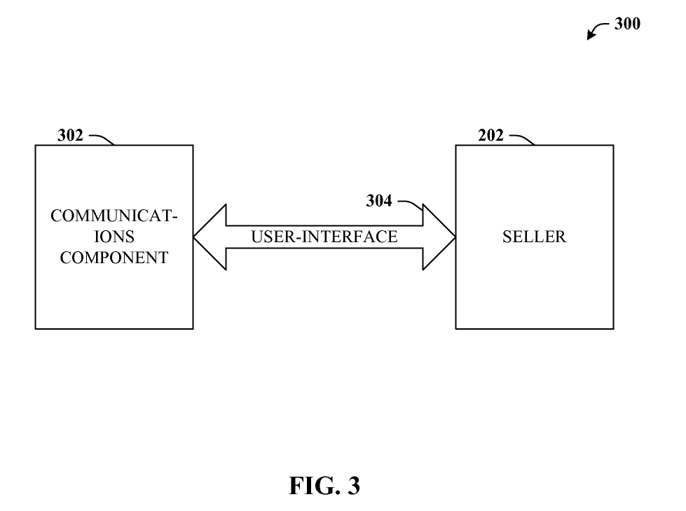

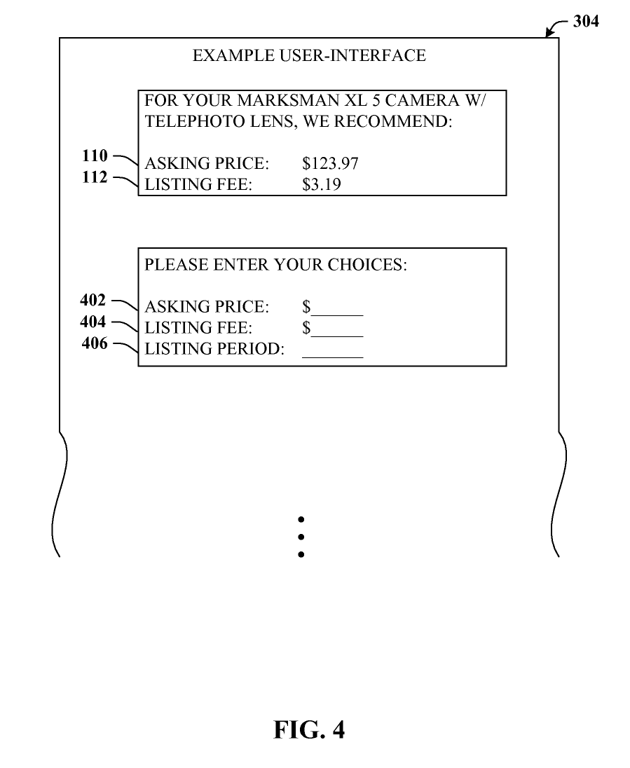

With reference now to FIG. 3, a system 300 that can facilitate communication with the seller is illustrated. In general, the system 300 can include a communications component 302 that can be operatively coupled to the evaluation component 108 and/or the acquisition component 102, or in some cases can be a component of one or both of the acquisition component 102 and the evaluation component 108. The communications component 302 can output the suggested asking price 110 and the suggested listing fee 112 to the seller 202 of the product for resale. In addition, the communications component 302 can receive from the seller 202 of the product a desired asking price for the product and a desired listing fee to a marketplace. In either case, the data exchanges between the communications component 302 and the seller 202 can occur by way of a user-interface 304, which can be can displayable to the seller 202 by a remote process or application running on a device or machine of the seller 202. FIG. 4 provides an exemplary illustration of the user-interface 304.

Turning now to FIG. 4, a depiction of one example user-interface 304 can be found. In this example, it is assumed that the seller 202 has previously entered suitable product data 104 relating to the product for resale, which is a Marksman XL 5 camera with a telephoto lens accessory. Based potentially upon many other similar competing products with associated ad/listings 204 in one or more various marketplaces, the evaluation component 108 can determine or infer the suggested asking price 110 and the suggested listing fee 112, as substantially described herein. This information can be output to the seller 202 by way of the user-interface 304 as shown or in another suitable manner.

Apprised of the aforementioned data, the seller 202 can make a more informed decision as to what are the market expectations are for the product relative to the seller's 202 own expectations. For example, in one illustrative example, the seller 202 might have thought her camera would only bring about $50, whereas in another case, the seller 202 might have believed that with all the extra features and accessories, her camera would be a steal at $200. In either situation, the suggested asking price 110 can result in a more rationally priced product than the seller 202 might have been able to determine on her own, even if she spent several hours researching competing products on her own time.

The user-interface 304 can also facilitate input of a desired asking price 402, a desired listing fee 404, a desired listing period 406, as well as many other aspects related to configurable data points with respect to the resale of the product. The desired asking price 402 can be a price for which the seller 202 is willing to sell the product, and more particularly the price that will appear in an associated ad or listing for the product. The desired listing fee 404 can be an amount the seller 404 is willing to pay to the market for hosting the ad or listing. The desired listing period 406 can represent a desired sell-by date or period. These and other data points can be received by the communications component 302 and provided to the evaluation component 108 for additional analysis as described in more detail with reference to FIG. 5.

Referring now to FIG. 5, a system 500 that can provide recommendations to increase a likelihood of conversion for the product is depicted. As indicated supra, the communications component 302 can forward the desired asking price 402, desired listing fee 404, et al., to the evaluation component 108. Based at least in part upon this information, the evaluation component 108 can provide certain inferences 502 and/or suggestions 504, that will be described in greater detail infra. According to one aspect, the evaluation component 108 can determine or infer (e.g. an inference 502) a number of impressions a listing for the product is likely to receive in a product marketplace. In effect, unless an advertisement or listing of the product receives an impression (e.g., a click-thru or view by a potential buyer), there little or no chance that a potential buyer will be aware of the product, and, therefore, little or no chance the product will be resold.

Such a situation is not likely to benefit either the seller 202 of the product or a host 506 of an ad or listing for the product. As is typically the case in resale marketplaces, the host 506 receives an associated listing fee only after the product has been converted, so in many ways, the objectives of the seller 202 and the host 506 are in accord. That is, both parties are likely to benefit from a conversion of the product, which, as with any form of advertisement, can heavily depend upon the number of impressions a listing receives. At one level, the desired asking price 402 can impact the number of impressions. For instance, a product with a desired asking price 402 that is well above the suggested asking price 110 can result in fewer impressions, as the high price may dissuade further interest from potential consumers, or rank the listing below many other competing products when, e.g. sorted by price. Conversely, a product with a desired asking price 402 that is well below the suggested asking price 110 can result in a greater number of impressions.

At another level, the desired listing fee 404 can also impact the number of impressions the product is likely to receive. As one example, consider a desired asking price 402 for a product that is well above the suggested asking price 110. In this case, the host 506 may not believe listing the product represents a favorable cost-benefit in terms of resource allocation, marketplace goodwill, and a host of other factors. However, by increasing the desired listing fee 404 above the suggested listing fee 112, the cost-benefit can undergo a favorable shift. Hence, the host 506 can be persuaded to utilize resources for listing the product despite the high desired asking price 402 due to a larger cut provided by a high desired listing fee 404.

Moreover, multiple hosts 506 can be encouraged to list the product or take various additional actions such as highlighting the product to potential buyers due to the higher desired listing fee 404. It should be underscored that while resale markets have traditionally been a province of auctions and want ads, by commoditizing products and product markets as described herein, other advertising and listing hosts can become more active in resale markets. For example, conventional web-based banner ads can be populated with listings for the product, a domain typically reserved for new or retail goods or services, given that the desired listing fee 404 can in some cases be set to provide better margins to the ad-host.

According to another aspect of the claimed subject matter, the evaluation component 108 can determine or infer a probability that an impression will result in a conversion of the product. Such an inference 502 can be substantially based upon the difference between the desired asking price 402 and the suggested asking price 110. Typically, a lower desired asking price 402 can lead to a higher conversion rate than a higher desired asking price 402.

In another aspect, the evaluation component 108 can determine or infer a probability of conversion of the product within a certain time period based at least in part upon the desired asking price 402 and the desired listing fee 404. It is to be appreciated that either the seller 202 or the host 506 may have various deadlines or time-related objectives for the product, the listing, a conversion of the product, and so on. Hence, such an inference 502 can be useful to both the seller 202 and the host 506, and can employ or relate to the aforementioned inferences 502 associated with a number of likely impressions and a conversion rate for the impressions. In accordance therewith, the evaluation component 108 can determine or infer a period of time in which the product is likely to be converted based upon the desired values 402 and 404, especially with respect to the suggested values 110, 112.

According to another aspect of the claimed subject matter, the communications component 302 can output the one or more probabilities and/or inferences 502 to the seller 202 or in some cases to the host 506. In addition, the evaluation component 108 can also provide suggestions 504 that relate to increasing the relevant probabilities. These suggestions 504 can also be provided to the seller 202 by way of the communications component 302. The suggestions 504 can relate to modifications to the desired asking price 402, the desired listing fee 404, the desired period 406, or another configurable data point relating to the product or a listing for the product.

For example, the suggestions 504 can indicate to the seller 202 that a 10% reduction in the desired asking price 402 can increase the likelihood of a conversion by 40%, or reduce the expected period for conversion by about one week. As another example, the suggestions 504 can indicate to the seller 202 that the desired asking price 402 can be increased by $30 without substantially effecting the likelihood of converting the product, or that the likelihood of converting the product will actually increase if the seller 202 increases the desired asking price 402 by $30 and accompanies that increase with a $2 increase in the desired listing fee 404. In another aspect, the evaluation component 108 can generate tables that can be provided to the seller 202 by the communications component 302. The tables can indicate the inferred or estimated effects that changes in the desired values 402-406 can have on the seller's bottom line or other objectives or goals. In addition, optimal data points can be highlighted as suggestions 504 in accordance with the seller's 502 preferences or particular objectives.

It is of course impossible to provide examples for all the various inferences 502 and suggestions 504 that can be accomplished by the evaluation component 108. However, those provided herein are intended to provide sufficient context as well as an indication of the scope and spirit of the appended claims. It is to be appreciated that the numerous determinations or inferences effected by the evaluation component 108 can be based upon predetermined templates or procedures, templates or procedures that adapt over time based, e.g., upon new data sets or changes to existing data, as well as based upon various machine-learning techniques.

The evaluation component 108 can employ a wide range of product data 104 as well as other suitable information, such as that stored in the data store 106 in order to make various determinations or inferences. In addition, the evaluation component can employ the data in the data store 106 to generate inferences relating to product classification such as a determination of which products represent competing products and, thus, potentially have a bearing upon the suggested values 110, 112. Further determinations can relate to isolating associated values of various features or accessories of the product, a brand or manufacturer, the current condition and so forth.

In particular, in one aspect, the evaluation component 108 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

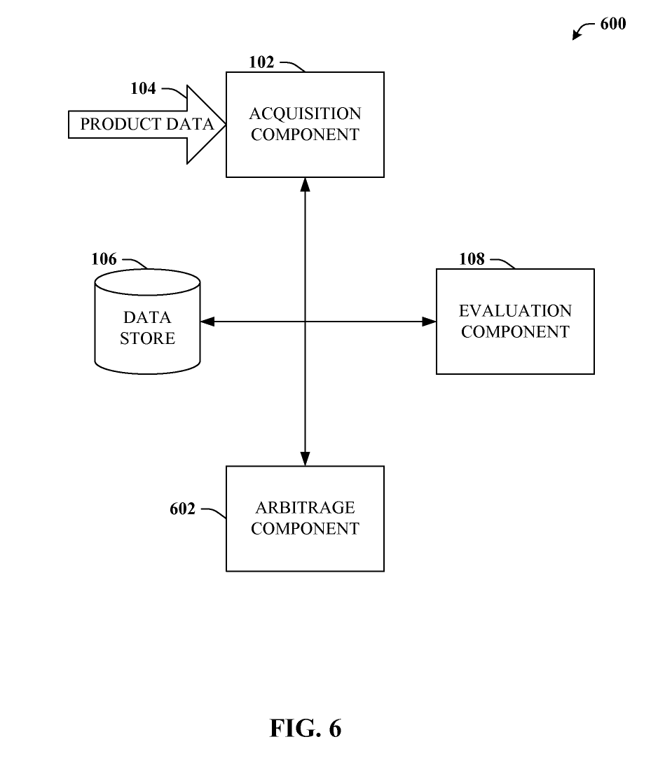

Referring to FIG. 6, a system 600 that can facilitate arbitrage opportunities is illustrated. Generally, the system 600 can include the acquisition component 102 that can obtain product data 104 associated with a product for resale. Product data 104 and other suitable information can be warehoused in the data store 106 and accesses and evaluated by the evaluation component 108 as substantially described supra. In addition to the described features, the evaluation component 108 can also identify certain product data 104, especially product data 104 that is obtained from a marketplace host 506 rather than directly from a seller 202, that is advantageously priced. An advantageously priced product can be a product in which the sum of the asking price and any additional charges or fees allocated to a buyer (e.g., shipping) is below the suggested asking price 110 minus the suggested listing fee, which can be inferred by the evaluation component 108.

A product that satisfies the above conditions can represent an arbitrage opportunity. Hence, in accordance therewith, the system 600 can include an arbitrage component 602 that can facilitate conversion and resale of an advantageously priced product. For example, the arbitrage component 602 can facilitate the purchase of the product at the designated asking price, then a subsequent resale of the product at the suggested asking price 110 and a suggested listing fee 112. Therefore, upon the resale of the product, the arbitrage component 602 receives in revenue the suggested asking price 110, and has in expenses the suggested listing fee 112 and the asking price for the advantageously priced product.

It is to be appreciated that the determination of an advantageously priced product can be optimized or appropriately set to offset various risk allocations such as the risk that no resale will result. In addition, it is to be appreciated that the suggested values 110, 112 can depend upon a desired listing time or time period, which can also vary in accordance with the objectives utilized by the arbitrage component 602. Thus, in addition to providing a potential for profiting, the arbitrage component 602 can increase liquidity for product markets, facilitate a convergence toward price uniformity, and generally aid in commoditization of the product market.

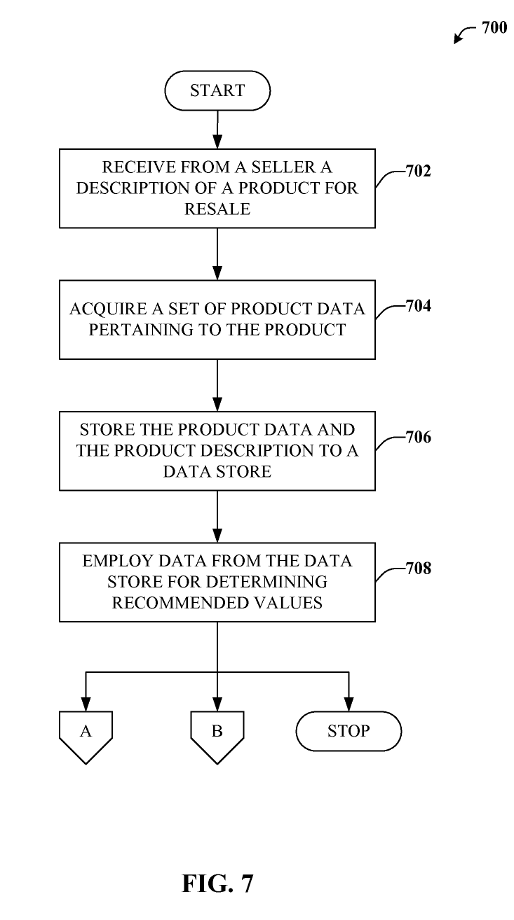

FIGS. 7, 8, and 9 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 7, an exemplary method 700 for commoditizing products and/or product markets in order to facilitate improved efficiencies in resale markets is illustrated. In general, at reference numeral 702, a description of a product for resale can be received from a seller of the product. The description can include a product class, subclass, or category, a manufacturer or brand name, a product model, product features or accessories, an age or condition of the product, as well as numerous other descriptive aspects of the product.

At reference numeral 704, a set of product data pertaining to the product can be acquired from one or both of a marketplace or from a previous or current owner of the product or a related product. For example, data pertaining to the product can be acquired from product listings associated with similar or competing products. The product listings can be available for access or display at any suitable marketplace venue such as an auction or want-ad listing. Likewise, the data pertaining to the product can be acquired from buyers or owners of the product, such as from a form or survey. It is to be understood that the owners can be provided incentives in exchange for the product data. At reference numeral 706, the product data and/or the product description can be stored to a data store, e.g. for archival purposes and for subsequent retrieval and examination.

At reference numeral 708, the data from the data store can be employed for determining a recommended asking price and a recommended listing fee. The recommended asking price can substantially represent a market or marketplace average worth or value of the product defined by the product description based upon obtained product data for similar or competing products. Similarly, the recommended listing fee can represent an average amount of remuneration a marketplace host received for hosting the product listing.

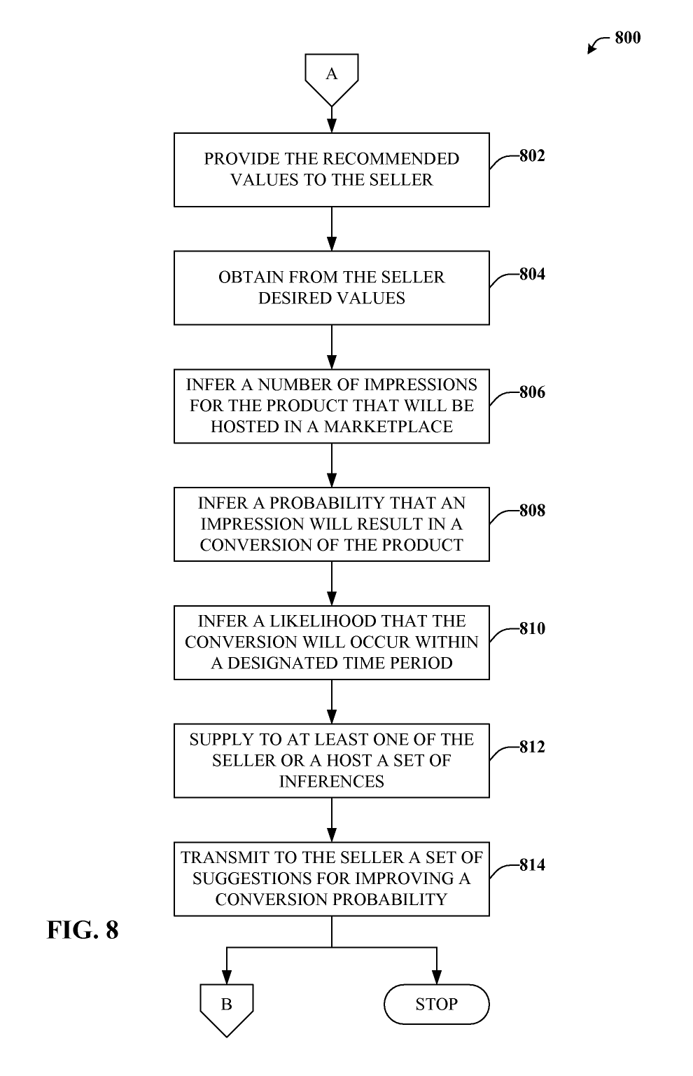

With reference now FIG. 8, an exemplary method 800 for providing inferences and/or suggestions for enhancing market performance is depicted. At reference numeral 802, the recommended asking price and the recommended listing fee can be provided to the seller of the product. Hence, the seller of the product can be apprised of a relative value or worth of the product according to a market for the product, as well as a price he or she can expect to pay to list the product on a given marketplace.

At reference numeral 804, a desired asking price and a desired listing fee can be obtained from the seller. The desired values are intended to represent actual values for a listing of the product, and can be identical, similar, and/or based upon the recommended values determined at act 708 of FIG. 7. At reference numeral 806, a number of impressions a listing of the product is likely to receive can be inferred. Similarly, at reference numeral 808, a probability that an impression will result in a conversion of the product can be inferred. Such inferences determined at acts 806 and 808 can be based upon the desired values obtained at act 804 as well as based upon numerous other data sets such as supply and demand for the product, market liquidity, host participation, bid activity, and so forth.

At reference numeral 810, a likelihood or probability that either an impression or the conversion will occur within a designated time period can be inferred. In particular, a designated time period can be utilized in connection with the inferences. At reference numeral 812, a set of inferences relating to the conversion of the product for resale can be supplied to at least one of the seller or the marketplace host. Likewise, at reference numeral 814, a set of suggestions for improving a conversion probability can be transmitted to the seller of the product. The set of inferences can be, e.g. the inferences associated with acts 806-810, whereas the set of suggestions can employ the aforementioned inferences to obtain a suggested modification intended to promote a sale of the product. Hence, either or both of the seller or the marketplace host can be apprised of beneficial information relating to products, product listings, or advertisements. Moreover, both parties can utilize the information provided to, e.g. optimize profits according to respective goals or objectives often in a symbiotic way that can facilitate benefits to the overall market as well.

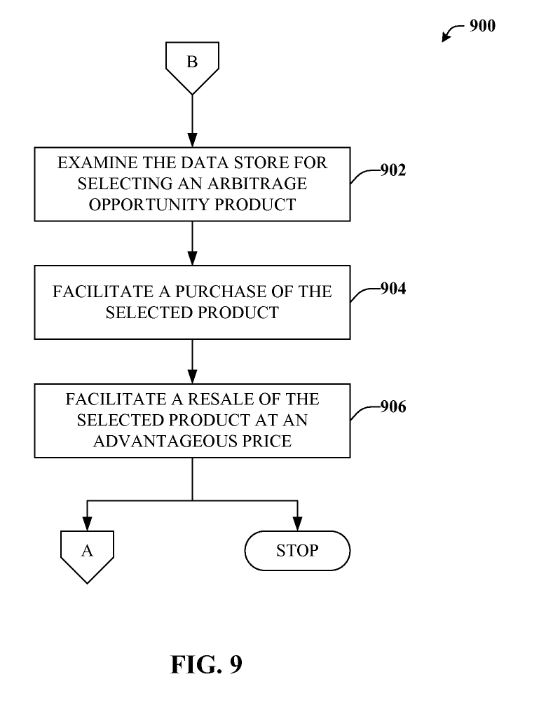

Turning now to FIG. 9, an exemplary method 900 for identifying and/or engaging in arbitrage opportunities is illustrated. In general, at reference numeral 902, the data store (e.g. the data store associated with act 706 of FIG. 7) can be examined for selecting an arbitrage opportunity. It is to be appreciated that a suitable arbitrage opportunity can exists when all associated transaction costs are some amount less than expected transaction revenues. The recommended asking price determined at act 708 can be a proxy for the expect transaction revenues, whereas the recommended listing fee and the asking price for the listing identified as an arbitrage opportunity can represent some of the transaction costs. It is to be appreciated that other miscellaneous fees can be included in the transaction costs such as shipping charges and the like.

At reference numeral 904, a purchase of the product selected as an arbitrage opportunity can be facilitated. For example, suitable actions can be performed such as bidding on and/or purchasing the selected product, as well as other suitable transactions or communications involving the product, product listing, seller, or listing host. At reference numeral 906, a resale of the selected product can be facilitated at an advantageous price. For instance, the selected product purchased at act 904 can be re-listed for sale, with the same or another market host, and, generally with an asking price substantially similar to the recommended asking price determined at act 708.

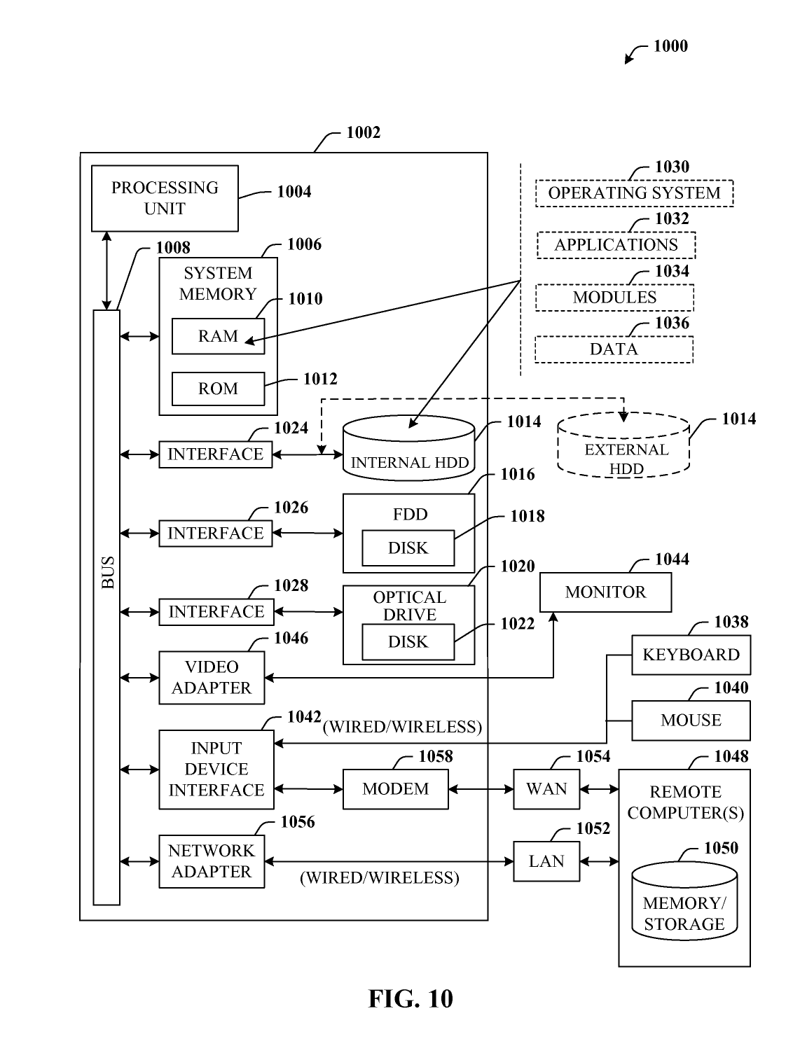

Referring now to FIG. 10, there is illustrated a block diagram of an exemplary computer system operable to execute the disclosed architecture. In order to provide additional context for various aspects of the claimed subject matter, FIG. 10 and the following discussion are intended to provide a brief, general description of a suitable computing environment 1000 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the claimed subject matter includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g. a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g. a wide area network (WAN) 1054. Such LAN and WAN networking environments are commonplace in offices and companies, and facilitate enterprise-wide computer networks, such as intranets, all of which may connect to a global communications network, e.g. the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

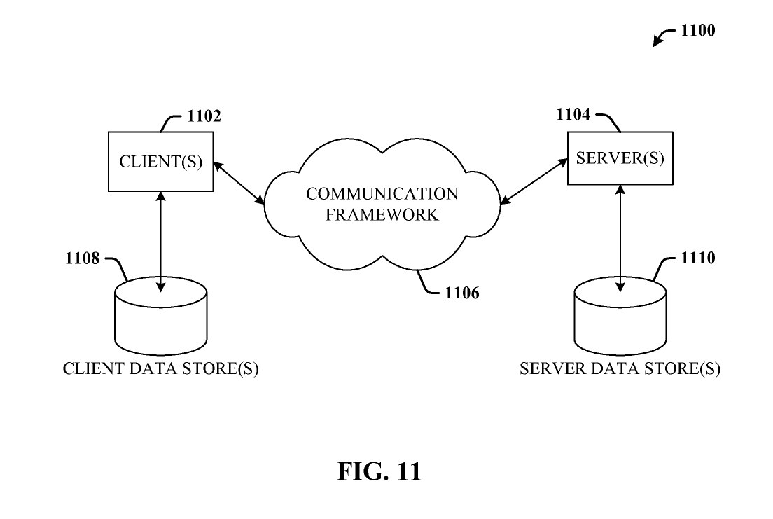

Referring now to FIG. 11, there is illustrated a schematic block diagram of an exemplary computer compilation system operable to execute the disclosed architecture. The system 1100 includes one or more client(s) 1102. The client(s) 1102 can be hardware and/or software (e.g., threads, processes, computing devices). The client(s) 1102 can house cookie(s) and/or associated contextual information by employing the claimed subject matter, for example.

The system 1100 also includes one or more server(s) 1104. The server(s) 1104 can also be hardware and/or software (e.g., threads, processes, computing devices). The servers 1104 can house threads to perform transformations by employing the claimed subject matter, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A computer-implement system that commoditizes products and/or product markets in order to facilitate improved efficiencies in resale markets, comprising:
an acquisition component that obtains product data associated with a product for resale; and
an evaluation component that determines based upon the product data a suggested asking price for the product and a suggested listing fee for a product marketplace.

2. The system of claim 1, the product data includes at least one of a product class, a product manufacturer, a product brand, a product model, a purchase price, a date of purchase, a product condition, a number of previous owners, a product feature, an included product accessory, an asking price, a listing fee, or a sell-by date.

3. The system of claim 1, the acquisition component obtains a portion of the product data as input from a seller of the product.

4. The system of claim 1, the acquisition component obtains a portion of the product data from an advertisement or listing of a competing product.

5. The system of claim 1, the acquisition component obtains a portion of the product data from an owner or purchaser of the product or a competing product.

6. The system of claim 1, the evaluation component determines the suggested asking price based at least in part upon an asking price associated with one or more competing products.

7. The system of claim 1, the evaluation component determines the suggested listing fee based at least in part upon a listing fee associated with one or more product marketplaces.

8. The system of claim 1, further comprising a communications component that outputs the suggested asking price and the suggested listing fee to a seller of the product.

9. The system of claim 1, further comprising a communications component that receives from a seller of the product a desired asking price for the product and a desired listing fee to a marketplace.

10. The system of claim 9, the evaluation component infers a number of impressions a listing of the product is likely to receive in a product marketplace.

11. The system of claim 9, the evaluation component infers a probability that an impression will result in a conversion of the product.

12. The system of claim 9, the evaluation component infers a probability of conversion of the product within a certain time period based at least in part upon the desired asking price and the desired listing fee.

13. The system of claim 12, the communications component outputs the probability to the seller.

14. The system of claim 13, the evaluation component provides suggestions to increase the probability, the suggestions relating to at least one of the desired ask price, the desired listing fee, or a desired period in which to convert the product.

15. The system of claim 12, the communications component outputs the probability to a product marketplace host.

16. The system of claim 1, further comprising an arbitrage component that facilitates conversion and resale of an advantageously priced product, the advantageously priced product has an asking price that is less than the suggested asking price minus the suggested listing fee.

17. A computer-implemented method for commoditizing products and/or product markets in order to facilitate improved efficiencies in resale markets, comprising:
receiving from a seller a description of a product for resale;
acquiring a set of product data pertaining to the product from at least one of a marketplace or an owner of the product or a similar product;
storing the product data and the product description to a data store;
employing data from the data store for determining a recommended asking price and a recommended listing fee.

18. The method of claim 17, further comprising at least one of the following acts:
providing the recommended asking price and the recommended listing fee to the seller;
obtaining from the seller a desired asking price and a desired listing fee;
inferring a number of impressions a listing of the product is likely to receive;
inferring a probability that an impression will result in a conversion of the product;
inferring a likelihood that an impression or the conversion will occur within a designated time period;
supplying to at least one of the seller or a marketplace host a set of inferences relating to the conversion of the product; or
transmitting to the seller a set of suggestions for improving a conversation probability.

19. The method of claim 17, further comprising at least one of the following acts:
examining the data store for selecting a product representing an arbitrage opportunity;
facilitating a purchase of the selected product; or
facilitating a resale of the selected product at an advantageous price.

20. A computer-implemented system for commoditizing products and/or product markets, comprising:
computer-implemented means for obtaining from a seller a description of a product for resale;
computer-implemented means for acquiring from a marketplace a set of product data pertaining to the product;
computer-implemented means for saving the product data and the product description to a data store;
computer-implemented means for utilizing data from the data store for determining a suggested asking price and a suggested listing fee for the product.
